(19) United States
(12) Patent Application Publication
(10) Pub. No.: US 2011/0213593 A1
(43) Pub. Date: Sep. 1, 2011

(54) Rules based design system

(76) Inventor: Peter B. Wilson, Casuarina Beach (AU)

(21) Appl. No.: 12/927,825

(22) Filed: Nov. 24, 2010

Related U.S. Application Data
(60) Provisional application No. 61/264,659, filed on Nov. 26, 2009.

(51) Int. Cl. G06F 17/50

(52) U.S. Cl. 703/1

(57) ABSTRACT

A rules-based computer implemented design system stored on servers and databases of a facilitating entity is disclosed. The system includes selection by a user at a first location of a scaled floor plan template within a user defined building site The selected floor plan template is rendered as a scaled computer generated graphical representation of the floor plan template. The graphical representation is output on to media at a second location remote from the first location. The graphical representation is tailored to the geographic location of the building site and of meteorological data and local government rules are stored on the databases of the facilitating entity at the second location.

### BACKGROUND

Computer assisted floor plan and home design drawing is well known in the art. This has led to online services that assist end users by supplying them with tools and templates that allow them to choose and design their own homes and floor plans using a web based interactive service. An example of this is www.MyVirtualHome.com.au

While these tools are very powerful, they are missing the integration of basic architectural and other building related rules that can be applied to these existing tools to ensure that a more realistic result can be achieved from using online, self-service, home and floor plan design systems.

For example, the ability to ensure that adequate cross ventilation is built into the design or that the home be positioned on the site in such a way as to maximize heating and cooling efficiencies, are basic architectural considerations that are not currently integrated into existing tools and systems.

The Invention described herein is designed to address at least some of these issues.

### Notes

The term “comprising” (and grammatical variations thereof) is used in this specification in the inclusive sense of “having” or “including”, and not in the exclusive sense of “consisting only of”.
The above discussion of the prior art in the Background of the invention, is not an admission that any information discussed therein is citable prior art or part of the common general knowledge of persons skilled in the art in any country.

### BRIEF DESCRIPTION OF INVENTION

Accordingly in one broad form of the invention there is provided a rules-based computer implemented design system stored on servers and databases of a facilitating entity; said system including selection by a user at a first location, of a scaled floor plan template within user defined building site boundaries; said selected floor plan template rendered as a scaled computer generated graphical representation of said floor plan template on said user defined building site; said representation output on media at a second location remote from said first location; said graphical representation tailored to a geographic location of said building site and with application of meteorological data and local government rules stored on said databases of said facilitating entity at said second location.

Preferably said scaled selected floor plan template is selected from a plurality of floor plan templates; said plurality of floor plan templates stored on servers and databases maintained by said facilitating entity.

Preferably a first selection of a first set of floor plan templates is made from said plurality of floor plan templates according to a first set of input data entered by a said user into interface screens made available to a said user by said facilitating entity over a communication system known as the Internet; said first set of input data relating to geographic location of a nominated said user defined building site.

Preferably said system generates derived data from said first set of input data; said derived data including meteorological, solar radiation and solar orientation data; said derived data combined with said local government rules stored on said databases of said facilitating entity; said derived data and said local government rules determining said first set of floor plan templates.

Preferably a second selection of a second set of floor plan templates is made from said first set of floor plan templates according to a second set of input data entered by said user into said interface screens; said second set of input data including sizes and orientation of said user defined building site.

Preferably said system generates derived data from said second set of input data; said derived data including cooling and heating requirements with reference to architectural and energy efficiency rules stored on databases of said facilitating entity.

Preferably said second set of input data includes number of rooms to be provided in floor plan templates of said second set of floor plan templates.

Preferably said second set of input data includes requirement of a family room provision in floor plan templates of said second set of floor plan templates.

Preferably said second set of input data includes requirement of en-suite provision with a main bedroom in floor plan templates of said second set of floor plan templates.

Preferably said second set of floor plan templates is made available by said facilitating entity for display on a said user's computer monitor; said user selecting at least one final floor plan template for output processing by said facilitating entity.

Preferably said facilitating entity outputs to media a scaled representation said at least one final selected floor plan template from said second set of floor plan templates; said selected floor plan template represented to scale on a scaled representation of said user defined building site.

Preferably said media includes a paper copy printed from said facilitating entity's printer.

In a further broad form of the invention there is provided a method of providing a selection of suitable floor plan templates for a building on a user defined building site; said method including the steps of:
(a) establishing a design system stored on servers and databases maintained by a facilitating entity,
(b) including in said design system a rules management system,
(c) further including in said design system a plurality of floor plan templates,
(d) providing, by means of the Internet, access by users to data input screens at a first or user's location, and
   wherein selected ones of said selection of suitable floor plan templates are output to media at said facilitating entity's printer at a second location remote from said first location.

Preferably input to said design system by said user includes location, size and orientation of said user defined building site.

Preferably input data entered into said interface screens by a said user is combined by said design system with rules maintained by said facilitating entity in databases of said system; said data and said rules determining said selection of suitable floor plan templates from said plurality of floor plan templates.

Preferably said rules include local government rules relating to buildings applicable in said location.

Preferably said rules include general architectural building guidelines.

Preferably said rules include energy efficiency guidelines.

Preferably output to a said user's computer includes at least scaled representations of selected floor plan templates shown within boundaries of said user defined building site; said output available from said facilitating entity.

In a further broad form of the invention there is provided a computer readable medium incorporating code executable to perform the method described above.

In a further broad form of the invention there is provided a computer readable medium incorporating code executable to effect the system described above.

### BRIEF DESCRIPTION OF DRAWINGS

FIG. 1—Overview of a preferred implementation of a rules management system according to the invention,

FIG. 2—Overview of the rules management system of FIG. 1

FIG. 3—is a schematic representation of an interactive template selection system

FIG. 4—Example initial user interface screen

FIG. 5—Example second user interface screen

FIG. 6—Example third user interface screen

FIG. 7—Example fourth user interface screen

FIG. 8—Example of a further user interface selection screen.

### DETAILED DESCRIPTION OF PREFERRED EMBODIMENTS

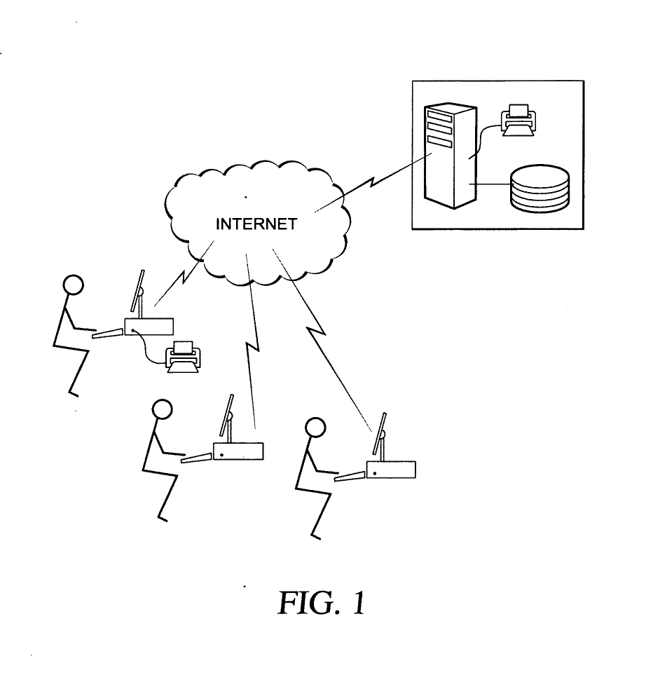

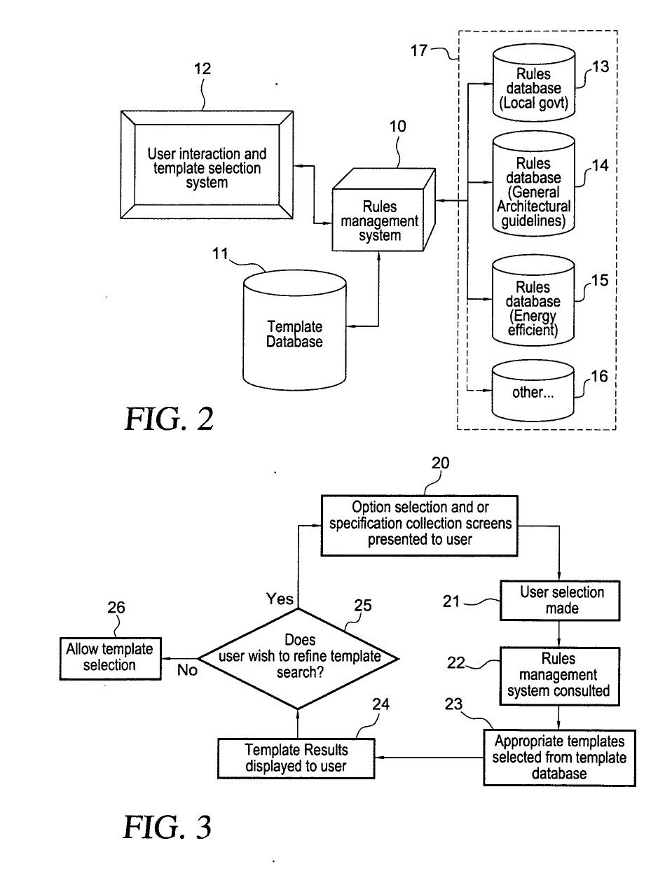

With reference to FIGS. 1 and 2, FIG. 1 shows an overview of a rules management system 1 including a rules management application 10 that enables selection by users 2 of the rules management system 1 of relevant floor plan templates from a database of floor plan templates. The rules management application 10 is maintained on servers 3 and databases 4 controlled by a facilitating entity 5 and made available to a user at a first, that is at the user's location, over the Internet 6.

Floor plan templates made available to users 2, are displayed on the user's computer monitor 7 using an interactive selection system 12 (see FIG. 2) which is usually a browser based application running on an Internet connected personal computer. The rules management application 10 uses databases 13 to 16 of building and site design rules in addition to a large selection of floor plan design templates from a template database 11.

When a selection process is complete, the selected floor plan and associated data may be printed onto media at a second location, that is, at the location of the facilitating entity 5.

In the example embodiment, there are provided databases 13 containing local government rules such as maximum building height, local building codes and the setback of the building from the borders of the property. Another example of a rules database may be a database 14 for general architectural guidelines such as the position of the house relative to the direction of prevailing winds and solar radiation based on the longitude and latitude of the property site which may dictate the ideal width of eaves, locations and sizes of windows to ensure shade in summer and sun in the winter. Yet another example could be an energy efficiency database 15 that contains rules about cooling or heating requirements based on the average temperatures of the area, or supply feasibility feedback on the viability of wind or solar power for the site. Additional rules 16 can be added indefinitely to allow users to tap into the knowhow and experience of hundreds of building professionals.

FIG. 3 shows an interactive template selection system that involves a cycle of interactions between the user 2 and the rules management system 10. The user 2 is presented with a series of screens 20 that request the user to select various options or provide information to help the rules system fine tune the selections presented to the user by the system. Once the user selection is made, or the information gathered 21, the rules management system is consulted 22 and, using the rules databases and the rules management application 10, a selection is made 23 of the most appropriate floor plan templates to display to the user 24. At any time the user can select a template from the results shown to them 26 or choose to refine the template search 25 by making further option selections or providing more information 20 to the system to further refine the search of templates available.

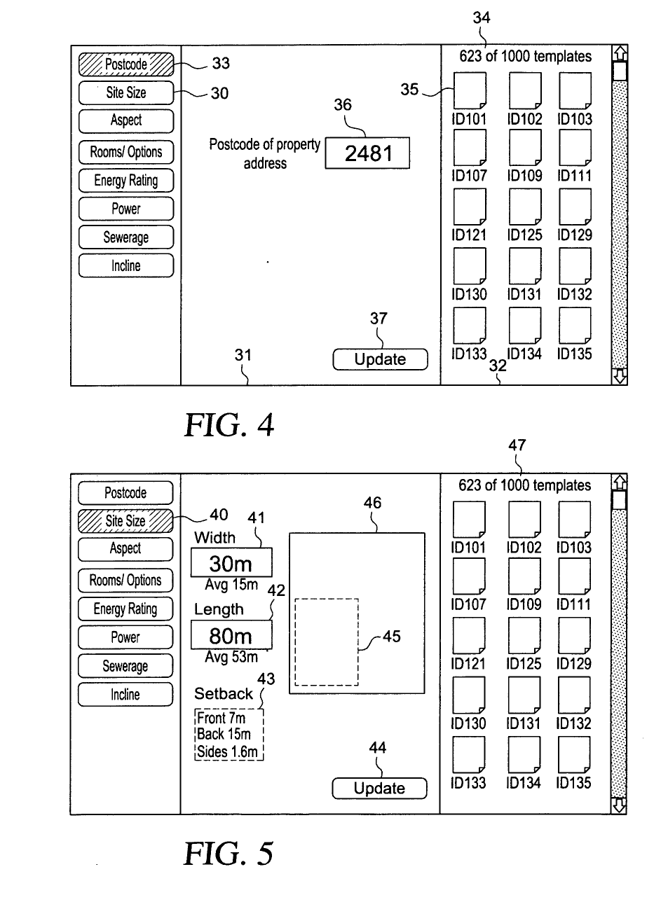

FIG. 4 shows the first of five example screens to demonstrate how the example embodiment may work. FIG. 3 shows a screen presented to the user that comprises three main sections or areas. Building information collection and option setting are collected in a series of screens linked to buttons 33 in a selection area 30 on the screen.

The second main area of the screen 31 is used for data collection from the user and to allow the user to make option selections. A third area 32 shows a listing of templates that are available based on the users current selected options and the data entered.

In the example first screen, the postcode button 33 is shown as selected. This screen has been used to obtain the postcode 36 of the property address. When the update button 37 is pressed the rules management system consults the rules management application 10 which in turn consults the rules databases 17 for appropriate rules to apply. Examples of these rules could be local government rules for setback dimensions, prevailing winds, average winter and summer temperatures, the height of the sun in summer and winter at that location to estimate eave widths and limitations on building height. Following this the eligible templates are filtered from the full list of templates available and displayed to the user for possible selection 32. In this example embodiment, the choice of postcode of 2481 reduces the number of templates available for this location from one thousand to six hundred and twenty three 34,

In FIG. 5, the second screen in the sequence, the site size is specified 40. A representation of a standard building block typical of the postcode area, is shown 45 to scale in comparison with the actual site size 46 in terms of width 41 and length 42. Also on this screen are displayed the setback dimensions 43 which have been retrieved from a local government rules database 13 based on the postcode 36 entered on the previous screen. In this instance the selection of the site length and width does not change the number of available templates 47 from which the user may select after selecting the Update button 44.

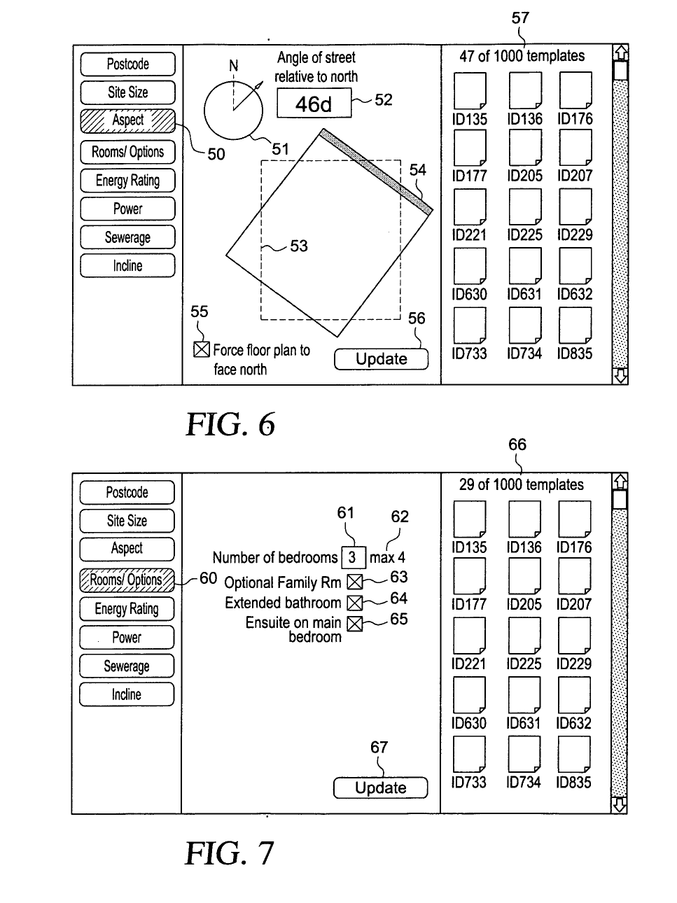

In FIG. 6, the third screen in the sequence of screens, the angle or aspect of the block relative to the street is defined by the user. The aspect button 50 is shown as selected and the user has moved the aspect arrow 51 or typed in a specific angle of forty six degrees into the aspect selection box 52. The interactive representation of the site shows the original and modified position 53 and 54 respectively of the site, with a bar showing where the street boundary would appear. The option to force the floor plan to face north 55, has been selected. This option will help the rules system find a template solution that has the most efficient heating and cooling characteristics. With this limitation combined with the space available, the rules system has reduced the number of templates available to the user from six hundred and twenty three in the second screen to forty seven in this screen 57.

In FIG. 7, the fourth screen in the series of screens, the user is allowed to select the number of bedrooms they wish to have in their home 61 and whether they would like an additional family room 63, an extra large main bathroom 64 and an en-suite on the main bedroom 65. There is also an automatic limit on the number of bedrooms available for the current floor plan based on the size of the land available for building on the block and the height or multi-story limitations made by the local government.

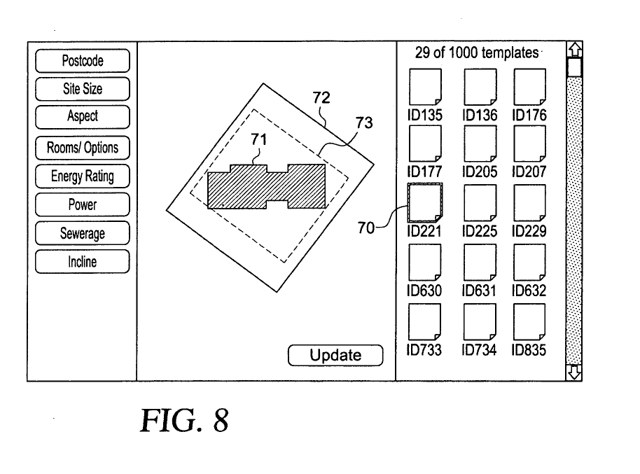

FIG. 8 shows a screen where the user has made a selection of a specific template 70 offered by the rules system. The floor plan template 71 has been displayed on the site 72 to scale with an outline defining the setback imitations 73 supplied by the local government rules database.

The system thus provides for the display of the boundaries of the user's nominated building site together with the selected floor for printing onto suitable media at the location of the facilitating entity, that is at a location remote from that of the user.

The representation of the floor plan and building site is reproduced to scale at the optimum solar orientation on the selected media, typically paper. The output of the user's site and selected floor plan template may be augmented by data derived from inputs provided by the user and based on the design rules and local government regulations appropriate to the floor plan template and site location respectively.

Preferably, the final floor plan template generated through the selection criteria applied by the user from his or her remote location, is made available in its printed form at a consultation with an architect representative of the facilitating entity. This consultative process may lead to further refinement as a result of a better understanding of the user's needs and a better understanding by the user of the implications of the applied criteria.

### Alternative Embodiments

The example embodiment has been defined using a limited number of rules and possible rules databases. The invention is designed to handle an indefinite number of rules and rules databases.

The example embodiment illustrates a method of selecting a floor plan from predefined house designs. An alternative embodiment, or additional features of the above describe embodiment, could apply appropriate rules to sub components of a floor plan, including but not limited to, individual rooms or parts of rooms, or how they are connected to the body of the house. Yet another embodiment or further features, could allow roof designs, septic systems, interior or exterior finishing or built-in components or any other component of a house or building amenable to rule-based design.

Another embodiment could see multiple template databases connected to the rules application to allow builders, developers and architects from other companies and third parties to use the rules management system.

In the example embodiment the results display a floor plan placed on a site of specified dimensions with setback rules defined by local government. An alternative embodiment could show the house rendered as a CAD CAM or computer generated structure in place on a landscape supplied from a topographically correct satellite image database such as Google Earth.

1. A rules-based computer implemented design system stored on servers and databases of a facilitating entity; said system including selection by a user at a first location, of a scaled floor plan template within user defined building site boundaries; said selected floor plan template rendered as a scaled computer generated graphical representation of said floor plan template on said user defined building site; said representation output on media at a second location remote from said first location; said graphical representation tailored to a geographic location of said building site and with application of meteorological data and local government rules stored on said databases of said facilitating entity at said second location.

2. The system of claim 1 wherein a said scaled selected floor plan template is selected from a plurality of floor plan templates; said plurality of floor plan templates stored on servers and databases maintained by said facilitating entity.

3. The system of claim 2 wherein a first selection of a first set of floor plan templates is made from said plurality of floor plan templates according to a first set of input data entered by a said user into interface screens made available to a said user by said facilitating entity over a communication system known as the Internet; said first set of input data relating to geographic location of a nominated said user defined building site.

4. The system of claim 3 wherein said system generates derived data from said first set of input data; said derived data including meteorological, solar radiation and solar orientation data; said derived data combined with said local government rules stored on said databases of said facilitating entity; said derived data and said local government rules determining said first set of floor plan templates.

5. The system of claim 4 wherein a second selection of a second set of floor plan templates is made from said first set of floor plan templates according to a second set of input data entered by said user into said interface screens; said second set of input data including sizes and orientation of said user defined building site.

6. The system of claim 5 wherein said system generates derived data from said second set of input data; said derived data including cooling and heating requirements with reference to architectural and energy efficiency rules stored on databases of said facilitating entity.

7. The system of claim 5 wherein said second set of input data includes number of rooms to be provided in floor plan templates of said second set of floor plan templates.

8. The system of claim 5 wherein said second set of input data includes requirement of a family room provision in floor plan templates of said second set of floor plan templates.

9. The system of claim 5 wherein said second set of input data includes requirement of en-suite provision with a main bedroom in floor plan templates of said second set of floor plan templates.

10. The system of any one of claims 5 to 9 wherein said second set of floor plan templates is made available by said facilitating entity for display on a said user's computer monitor; said user selecting at least one final floor plan template for output processing by said facilitating entity.

11. The system of claim 10 wherein said facilitating entity outputs to media a scaled representation said at least one final selected floor plan template from said second set of floor plan templates; said selected floor plan template represented to scale on a scaled representation of said user defined building site.

12. The system of claim 11 wherein said media includes a paper copy printed from said facilitating entity's printer.

13. A method of providing a selection of suitable floor plan templates for a building on a user defined building site; said method including the steps of:
a. establishing a design system stored on servers and databases maintained by a facilitating entity,
b. including in said design system a rules management system,
c. further including in said design system a plurality of floor plan templates,
d. providing, by means of the Internet, access by users to data input screens at a first or user's location, and
e. wherein selected ones of said selection of suitable floor plan templates are output to media at said facilitating entity's printer at a second location remote from said first location.

14. The method of claim 13 wherein input to said design system by said user includes location, size and orientation of said user defined building site.

15. The method of claim 13 or 14 wherein input data entered into said interface screens by a said user is combined by said design system with rules maintained by said facilitating entity in databases of said system; said data and said rules determining said selection of suitable floor plan templates from said plurality of floor plan templates.

16. The method of claim 15 wherein said rules include local government rules relating to buildings applicable in said location.

17. The method of claim 15 wherein said rules include general architectural building guidelines.

18. The method of claim 15 wherein said rules include energy efficiency guidelines.

19. The method of claim 13 wherein output to a said user's computer includes at least scaled representations of selected floor plan templates shown within boundaries of said user defined building site; said output available from said facilitating entity.

20. A computer readable medium incorporating code executable to perform the method of claim 13.

21. A computer readable medium incorporating code executable to effect the system of claim 1.

22. Computer-readable media including instructions to effect a rules-based computer implemented design system stored on servers and databases of a facilitating entity; said system including selection by a user at a first location, of a scaled floor plan template within user defined building site boundaries; said selected floor plan template rendered as a scaled computer generated graphical representation of said floor plan template on said user defined building site; said representation output on media at a second location remote from said first location; said graphical representation tailored to a geographic location of said building site and with application of meteorological data and local government rules stored on said databases of said facilitating entity at said second location.
